(19) United States
(12) Patent Application Publication
(10) Pub. No.: US 2008/0080346 A1
(43) Pub. Date: Apr. 3, 2008

(54) DETECTION METHOD OF PERIPHERAL SURFACE DEFECT OF DISK AND DETECTION DEVICE THEREOF

(76) Inventors: Shigeru SERIKAWA, Kanagawa (JP); Takayuki ISHIGURO, Kanagawa (JP)

Correspondence Address: MATTINGLY, STANGER, MALUR & BRUNDIDGE, P.C.;Suite 370, 1800 Diagonal Road, Alexandria, VA, 22314, US

(21) Appl. No.: 11/865,346

(22) Filed: Oct. 1, 2007

(30) Foreign Application Priority Data
Oct. 2, 2006 (JP) 2006-270329

(51) Int. Cl. G11B 5/58

(52) U.S. Cl. 369/53.17

(57) ABSTRACT

A regularly reflected light made incident with an incident angle in a range of 45°±5° with respect to a surface of a chamfered portion of a disk is received by a light receiver The level reduction in the received light signal due to a flaw caused by the chuck traces is increased greatly to enlarge the level difference between the detection signals due to foreign matter and due to the flaw. Thereafter, the variation of signal reference level in the received light signal due to shifting in the up and down direction of the outer peripheral surface of the disk caused by rotation thereof is suppressed or canceled out. Thereby, the detection signal of the outer peripheral defect of which level in the received light signal is greatly reduced can be easily obtained.

### FIELD OF THE INVENTION

The present invention relates to a detection method of a peripheral surface defect of a disk and a detection device thereof and, more specifically, relates to a detection method of a peripheral surface defect of a disk and a detection device thereof, which can detects with a high accuracy outer peripheral defects such as chuck traces, flaws and chips that remain when chucking a disk substrate without detecting most of foreign matters deposited on the outer peripheral surface which are one of the defects.

### BACKGROUND ART

A magnetic disk, which is one of information recording media such as for a computer, conventionally uses an aluminum disk as its raw material, however, in these days, due to a demand of its size reduction and high recording density, a glass disk is used as the raw material and on which a magnetic film is formed. The surfaces of a glass disk are polished and smoothened, however, during such polishing work and treatment thereof, the inner peripheral edge or the outer peripheral edge thereof sometimes chips and cracks. Due to such occurrence, since the quality of the disk reduces, such as chips and cracks are inspected and when the degree thereof low, the disk is polished again and when the degree thereof is high, the disk is determined as non-conforming article. The degree in size of such chips and cracks is inspected and judged by a defect inspection device.

With reference to FIG. 6, an outer peripheral edge portion of a glass disk and a chip defect thereof will be explained

In FIG. 6 (a), a glass disk 1 includes varieties of outer diameters and each of which has a center hole H with a predetermined diameter. FIG. 6 (b) shows a cross sectional view of the outer peripheral portion and in which a surface at the upper side is designated as 1a, a surface at the lower face (back face) as 1b and the side face of the outer periphery as 1c. In the disk 1, portions near the side face 1c are chamfered and an upper edge portion (herein below will be called as a chamfer) ChU and a lower chamfer ChU are formed, a range toward the inside from the side face 1c by a length of d is assumed as an outer peripheral edge portion E (outer peripheral face) and chips and cracks caused in this range are determined as peripheral surface defects K. Further, the length d varies depending on the size of the disk 1 and, for example, in the case of 2.5 inch disk, the length d is determined to be 0.2 mm.

A hard disk device (HDD) is spreading now a day into fields of such as automotive products, electric home appliances and audio products and hard disk drive devices for from 3.5 inch to 1.8 inch disk and still further for less then 1.0 inch disk are built-in in varieties of products and are used. Moreover, because of a magnetic head having high recording density and an improvement in head positioning accuracy, in these days in addition to a glass disk substrate (glass substrate), an inexpensive aluminum disk substrate (aluminum substrate) is frequently use and different substrates of these are used depending on different uses of HDD.

As one of conventional defect inspection devices of outer peripheral edges of a magnetic disk using a glass substrate, JP-A-7-190950, which is an invention of the present assignee, discloses a first light receiving system that receives scattered light of light directed to a chamfered portion in upper portion of the outer peripheral edge portion E at an incident angle of about 30° with respect to a normal line and in addition a second light receiving system that receives the scattered light in an direction opposing to the outer peripheral side face, and is known as a prior art.

Further, although not a peripheral defect detection device, JP-A-64-57154 discloses a defect detection device for detecting a defect on a disk surface in which linear shaped light beams are irradiated from an upper portion of a transparent disk to the disk surface to cause the same totally reflected inside the disk and the scattered light from the outer peripheral side face is received, and is known as a prior art.

In the case of an HDD having high recording density which makes use of an aluminum substrate or an aluminum magnetic disk using thereof as a substrate (herein below these are inclusively called as an aluminum disk), the width of the outer peripheral edge portion E or the chamfered portion of the disk is now a day narrow to less than 0.15 mm and tracks are formed as close as possible to the outer peripheral edge portion E. The thickness of a disk is about 0.5 mm˜1.3 mm depending on the outer diameter thereof, the chamfered angle is inclined at about 45°±5° and the width of the side face 1c is also narrowed.

The surface of such an aluminum disk is soft and is likely to be damaged by chuck traces at the time of the disk handling.

Since the chucking of a disk is usually and frequently performed at the edge (the chamfered portions and the side face) provided at the outer periphery of the disk, chuck flaws are likely caused at the chamfered portions. Since the chuck traces of the aluminum disk are shallow in comparison with flaws and cracks on a glass disk substrate, the size thereof is more or less 100 μm and the aluminum disk is an opaque raw material, transmission type detection can not be performed.

With regard to such chuck traces, which are smaller than conventional flaws, even when the traces are detected with the conventional outer peripheral edge defect detection method of a glass disk as disclosed in JP-A-7-190950, since the level of the detection signal is low, discrimination between foreign matters deposited on the chamfer and the chuck flaws is difficult, which is a drawback.

Further, a deposited foreign matter (herein below will be simply called as a foreign matter) can be removed by cleaning, however, a disk having a problematic chuck trace is either determined as nonconforming article or in some cases removed by polishing.

On the other hand, a glass disk frequently cracks before being formed of a chuck trace and in some instances, the crack is comparatively small. When defect detection is performed in such instances, since the level of the detection signal is low, it is hard to discriminate a chuck flaw from a foreign matter deposited on a chamfer.

One of the reasons why the chuck flaw cannot be discriminated from the foreign matter is a shifting of disk outer peripheral surface in up and down direction due to surface vibration of a disk for the inspection object caused by rotation thereof.

Namely, since the disk for the inspection object is mounted on a spindle and the defect inspection is performed under rotation thereof, a shifting in up and down direction in particular due to the disk surface vibration at the outer peripheral surface thereof is amplified at the time of defect detection. For this reason, a reference level in a detection signal of a flaw due to a chuck trace varies due to the shifting of the disk, which causes a problem that a detection signal of a flaw due to a chuck trace cannot be precisely separated from a detection signal of a foreign matter and the like. When such foreign matter is detected as a flaw or a defect, a yield of disks is deteriorated.

### SUMMARY OF THE INVENTION

An object of the present invention is to resolve these problems of the conventional art and to provide a detection method of a peripheral surface defect of a disk, which can detects with a high accuracy outer peripheral defects such as chuck traces, flaws and chips that remain when chucking a disk substrate without detecting most of foreign matters which are one of the defects.

Another object of the present invention is to provide a detection device of a peripheral surface defect of a disk, which can detects with a high accuracy outer peripheral defects without detecting most of foreign matters.

A detection method of a peripheral surface defect of a disk or a detection device of a peripheral surface defect thereof according to the present invention, which achieves these objects, is constituted in such a manner that light beams are irradiated on a surface of an outer peripheral chamfered portion of the disk that is rotatable with an incident angle in a range of 45°±5°, regularly reflected light from the outer peripheral chamfered portion is received by a light receiver provided away from the outer peripheral chamfered portion by a predetermined distance through a stop to obtain a received light signal and a detection signal of a defect on the outer peripheral surface is obtained while suppressing or canceling out a variation of signal reference level in the received light signal due to the shifting of the outer peripheral surface of the disk caused by the rotation of the disk.

In the above manner, according to the present invention, since the regularly reflected light made incident with the incident angle in a range of 45°±5° with respect to the surface of the chamfered portion is received by the light receiver through the stop, the level reduction in the received light signal due to a foreign matter, which generates much scattering light, is suppressed low so as to come close to that of noises and the level reduction in the received light signal due to the flaw and the like caused by the chuck traces is increased greatly to enlarge the level difference between the detection signals due to the foreign matter and due to the flaw. Thereafter, the variation of signal reference level in the received light signal due to the shifting in up and down direction of the outer peripheral surface of the disk caused by the rotation of the disk is suppressed or canceled out.

Thereby, the detection signal of the outer peripheral defect of which level in the received light signal is greatly reduced can be easily obtained.

In order to suppress or canceling out the variation of signal reference level in the received light signal, a reference level variation inhibiting circuit can be provided. An example of such circuits is a circuit in which a signal corresponding to the variation of the signal reference level is extracted from the received light signal as a detection reference signal through a low pass filter or a band pass filter and the detection reference signal and the received light signal are compared. Another example is a circuit in which variable components in the signal reference level in the received light signal are removed through a high pass filter and the defect detection signal is extracted from the received light signal.

With such reference level variation inhibiting circuit in the received light signal, flaws at the outer peripheral chamfered portion including flaws due to chuck traces are discriminated from foreign matters and outer peripheral defects can be detected without detecting most of foreign matters.

As a result, with the peripheral surface defect detection device to which the present invention is applied, defects such as flaws and chips due to chuck traces and the like at the outer peripheral chamfered portion of the disk can be detected efficiently and with a high accuracy while separating from foreign matters.

### BRIEF DESCRIPTION OF THE DRAWINGS

FIG. 1 is a view for explaining one embodiment of a peripheral surface defect detection device for an aluminum disk to which a peripheral surface defect detection method for a disk according to the present invention is applied,

FIG. 2 (a) is a view for explaining a case in which a foreign matter is deposited on a chamfered portion of a disk,

FIG. 2 (b) is a view for explaining a case in which a flaw due to a chuck trace and the like exists at a chamfered portion of a disk,

FIG. 3 is a view for explaining a detection signal obtained during one round rotation along a track,

FIG. 4 (a) is a view for explaining a signal waveform of a detection signal by a light receiver after being subjected to a filtering processing,

FIG. 4 (b) is a view for explaining a defect detection signal that has passed through a reference level variation inhibiting circuit,

FIG. 5 is a block diagram of a defect detection circuit that uses another reference level variation inhibiting circuit for a received light signal,

FIG. 6 (a) is a view for explaining a glass disk, and

FIG. 6 (b) is a view for explaining an outer peripheral edge portion and a defect of the glass disk.

### DESCRIPTION OF THE PREFERRED EMBODIMENT

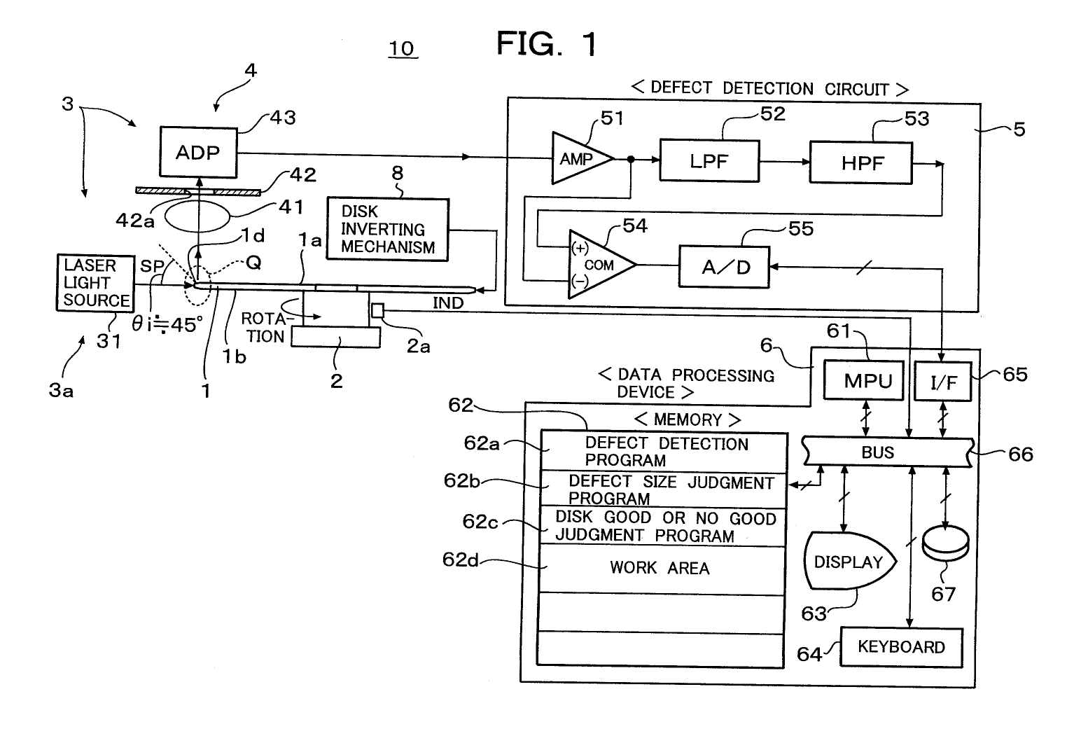

In FIG. 1, numeral 10 is a defect inspection device and is constituted by a spindle 2, a defect detection optical system 3, a defect detection circuit 5, a data processing device 6 and a disk inverting mechanism 8.

The defect detection optical system 3 is constituted by a light illuminating system 3a and a light receiving system 4.

The spindle 2 is rotated after an aluminum disk (herein below will be called as a disk) 1 for the inspection object is mounted thereto. The light illuminating system 3a irradiates a laser spot Sp from a light source (laser light source) 31 at an inspection region Q on an outer peripheral surface of the disk 1 with an incident angle θi nearly equal 45° with respect to the outer peripheral chamfered portion 1d at the side of a front face 1a of the disk 1.

The light receiving system 4 is constituted by an image-forming lens 41, a stop hole plate 42 and a light receiver 43. The stop hole plate 42 is provided between the light receiver 43 and the image-forming lens 41. As the case may be, the image-forming lens 41 could be omitted.

The light receiver 43 is an avalanche-photodiode (APD) and is disposed at the upper portion away from an outer peripheral chamfered portion 1d by a predetermined distance in perpendicular direction with respect to the front surface of the disk 1, and the light receiving face thereof receives regularly reflected light from the inspection region Q through the image-forming lens 41 and the stop hole plate 42.

Further, the incident angle θi is in a range of 45°±5° with respect to a normal line on the surface of the outer peripheral chamfered portion 1d at the side of the front face. The stop hole plate 42 includes a stop hole 42a having a size that only passes the regularly reflected light from the chamfered portion 1d. The diameter of the hole is adjustable. Although the diameter of the laser spot Sp is larger than the thickness of the disk 1, because of the disposition at the upper portion of the outer peripheral chamfered portion 1d in the perpendicular direction with respect to the front face 1a of the disk 1 and of the existence of the stop hole 42a, the light receiver 43 is permitted to receive only the regularly reflected light from the chamfered portion 1d.

In FIG. 1, numeral 5 is a defect detection circuit, which is constituted by a preamplifier (AMP) 51, an LPF (Low Pass Filter) 52, a HPF (High Pass Filter) 53, a comparing amplifier (COM) 54 and an A/D 55, and an output of the A/D 55 is sent out to a data processing device 6 and in the data processing device 6, number and size of defects at the chamfered portion 1d of the disk 1 are detected.

Herein, the LPF 52 is a circuit for extracting a reference signal in received light signals caused due to shifting in up and down direction of the disk outer peripheral surface, the HPF 53 is a circuit inserted between an output terminal of the LPF 52 and the ground GND and sinks high frequency noise components and detection signal components of such as flaws and foreign matters to the ground GND. Further, the comparing amplifier (COM) 54 functions as a circuit which cancels a variation of reference level in the received light signals caused due to shifting in up and down direction of the disk outer peripheral surface and generates detection signals of outer peripheral defects.

Detection signals of the light receiver 43 are input to (+) input of the comparing amplifier 54 via the preamplifier 51, the LPF (Low Pass Filter) 52 and the HPF (High Pass Filter) 53 in the defect detection circuit 5. (−) input of the comparing amplifier 54 receives an output of the preamplifier 51.

The data processing device 6 is constituted by such as an MPU 61, a memory 62, a display 63, a keyboard 64 and an interface circuit (I/F) 61 and these are mutually connected through a bus 66. Numeral 67 is an external memory device such as an HDD.

The memory 62 is provided with a defect detection program 62a, a defect size judgment program 62b, a disk good or no good judgment program 62c and a work area 62d.

Further, the MPU 61 receives from an encoder 2a provided at the side of the spindle 2 via the bus 66 an index signal IND obtained in response to one rotation of the disk as an interruption signal.

Numeral 8 is the disk inverting mechanism and is disposed adjacent to the disk 1 mounted to the spindle 2. The disk inverting mechanism 8 chucks the outer peripheral side face of the disk 1 with a chuck mechanism and receives the disk 1 by lifting up the same from the spindle 2. Then, the disk inverting mechanism 8 retreats on a rail (not shown) and sidetracks the disk 1 from the position of the spindle 2, and inverts the disk 1 of which inspection on the outer peripheral chamfered portion at the front side has been completed to turn the back side face thereof to the front side face, advances on the rail and returns the disk 1 over the spindle 2 to remount the same to the spindle 2. Further, since varieties of disk inverting mechanisms are known, a detailed explanation thereof is omitted.

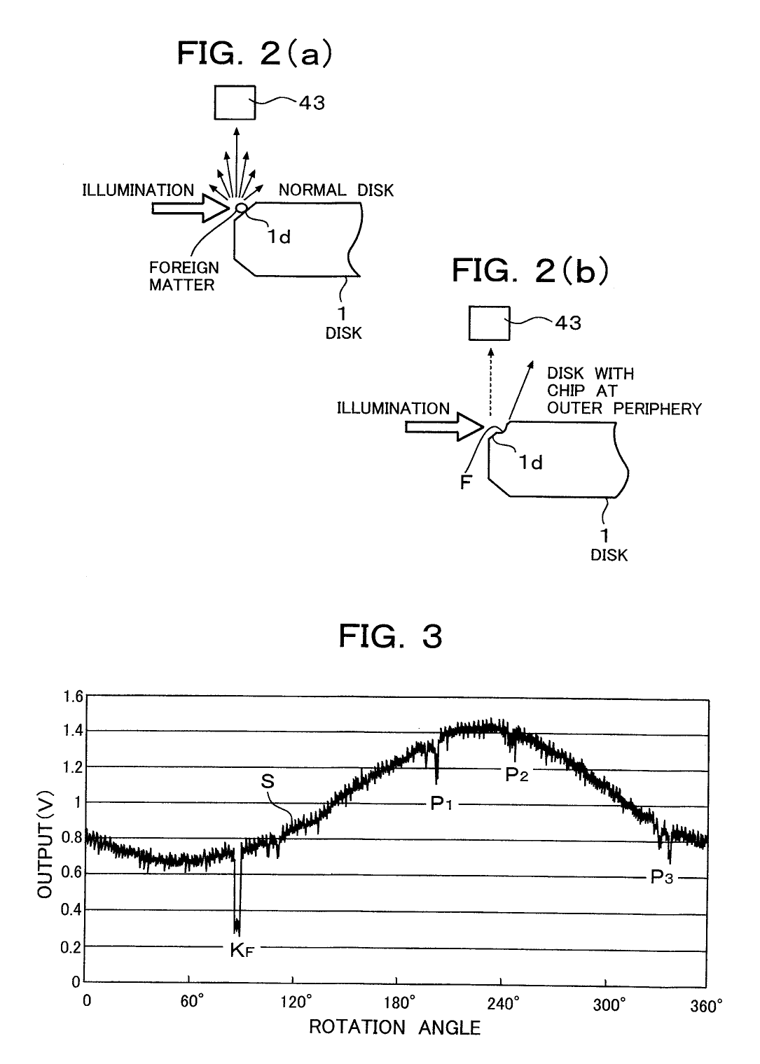

FIG. 2 is a view for explaining the outer peripheral defect detection in the defect detection optical system, wherein FIG. 2 (a) is a view for explaining a case when a foreign matter deposits on the chamfered portion 1d of the disk 1, and FIG. 2 (b) is a view for explaining a case when a flaw F due to chuck traces and the like exists on the chamfered portion 1d of the disk 1. Further, in these drawings, the stop 42 is omitted for the sake of convenient explanation.

As shown in FIG. 2 (a), when foreign matters exist on the chamfered portion 1d, since the foreign matters cause much forward-backward scattering lights and decrease regularly reflected light, respective waveforms as shown by points P1, P2 and P3 in FIG. 3 appear in a received light signal (detection signal S) of the light receiver 43, which receives regularly reflected light.

When a flaw F due to chuck traces and the like exists on the chamfered portion 1d of the disk 1, as shown in FIG. 2 (b), since the regularly reflected light greatly decreases, the received light signal of the light receiver 43 reduces and a pulse shaped waveform as shown by point KF in FIG. 3 is obtained as a detection signal of the flaw F. Contrary, the level reduction in the received light signal of the respective detection signals with the respective waveforms shown by point P1, point P2 and point P3 corresponding to foreign matters (herein below, will be called as detection signal at point P1, detection signal at point P2 and detection signal at point P3) is smaller than that of the detection signal with the waveform shown by point KF (herein below will be called as detection signal at point KF).

However, because of a variation of a reference level in the received light signal, when the detection signal at point KF is on the crest position of the detection signal S, when the level reduction thereof is small or oppositely when the level of the detection signal at point P3 of pulse like waveform is larger than that illustrated, discrimination therebetween sometimes becomes difficult.

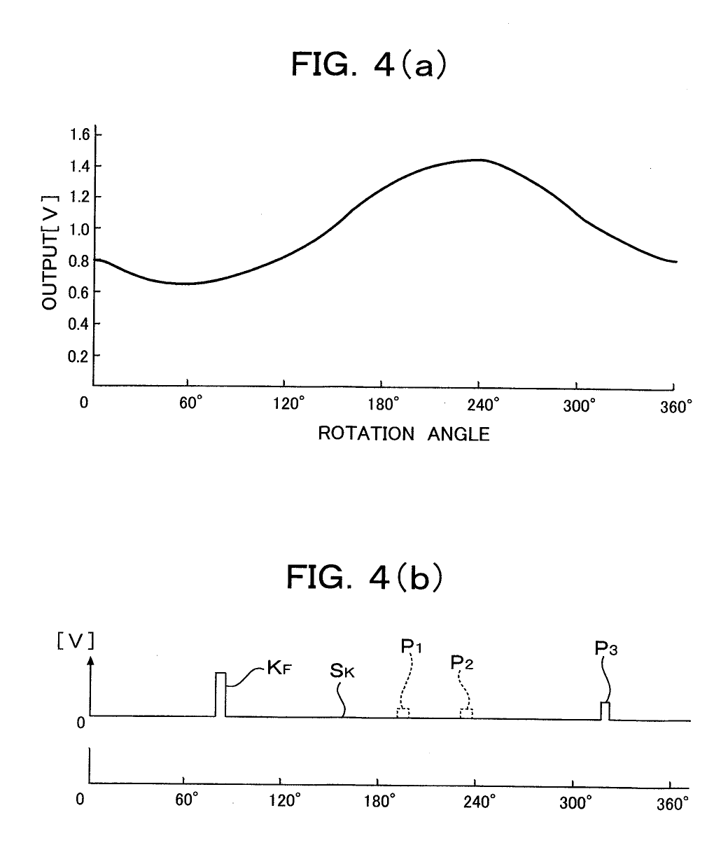

Therefore, the detection signal S is passed through the LPF (Low Pass Filter) 52 and the HPF (High Pass Filter) 53, wherein the signal components corresponding to the shifting of the disk 1 are caused to pass the LPF 52 and the remaining high frequency noises and the respective detection signal components at points P1, P2 and P3 and at point KF are sunk to the ground through the HPF 53 to remove the same, resultantly, a detection reference signal in a vibration waveform corresponding to the shifting of the disk 1 with substantially no noises are extracted from the detection signal S as shown in FIG. 4 (a).

By applying this vibration waveform to (+) input of the comparing amplifier (COM) 54, the variation of the reference signal level in the received light signal at (−) input side is canceled.

Since the detection signal S is not a complete sinusoidal waveform, the signal is necessary to be passed through these filters, however, when the filters are constituted to pass the signal components corresponding to the shifting in up and down direction of outer peripheral surface of a 2.5 inch disk, and while assuming that the rotation number of the spindle is, for example, 10,000 rpm and a cutoff frequency of the LPF 52 is, for example, 200 Hz, the filters can be used in common in the case for 1.5 inch disk.

Although indefinite depending on the rotation number of the spindle, the LPF 52 can use a BPF (Band Pass Filter), which extracts signal components in the detection signal S in correspondence with the frequencies thereof depending on the shifting in up and down direction of outer peripheral surface in the respective disks of one or plural diameters. Accordingly, the LPF 52 can be replaced by the BPF.

Therefore, as the result of comparing the signal in FIG. 4 (a) and the detection signal S in FIG. 3 in the comparing amplifier 53, the comparing amplifier 53 can obtain a defect detection signal Sk as shown in FIG. 4 (b) at positions of the respective detection signals at points P1, P2 and P3, which reduce in a pulse shaped signal and at point KF.

With this measure, not only the variation of the reference level in the received light signal is canceled, but also because the level reduction of the detection signals corresponding to foreign matters as shown by the respective detection signals at points P1 and P2 is small and comes close to those of noises, almost all such detection signals do not appear as an output from the comparing amplifier 54 as shown by dotted lines in FIG. 4 (b).

Since the comparing amplifier 54 is a high gain non-inverting DC amplifier, although high frequency noises in an input signal at (−) input thereof are possibly amplified, these are removed some by an operation dead band of the non-inverting DC amplifier and further, these are removed when sunk to the ground GND such as through a capacitor, although not illustrated. Thereby, the respective detection signals at points P1 and P2, which are close to high frequency noises, are removed.

As a result, the defect detection signal Sk as in FIG. 4 (b) can be obtained as an output of the comparing amplifier 54. Herein, detection signals in connection with many foreign matters are eliminated. Of course, in this instance, the high frequency noises are also not output.

As a result, ones detected in this instance are the pulse like detection signal possibly at point P3 with a comparatively large level reduction corresponding to a foreign matter and the detection signal KF corresponding to the flaw F. Since the respective detection signals at point P3 and at point KF are different in connection with extinction levels of the received light, the difference appears in the output of the comparing amplifier 54 as pulse signals having the corresponding levels. Moreover, the generation of the pulse like detection signal at point P3 is infrequent.

The A/D 55 receives the pulse signals corresponding to the respective signals at point P3 and at point KF as defect detection signals Sk. The levels of the signals are converted into digital values every time when the defect detection signal is generated to successively store the same in the work area 62d.

The data processing device 6 receives the index signal IDX and when an inspection of a chamfered portion for one round rotation of the disk 1 is completed, calls the defect detection program 62a. The defect detection program 62a is executed by the MPU 61, and the MPU 61 detects defect detection signals Sk having levels more than a predetermined value as defects (including chuck traces) on the chamfered portion 1d, stores the level values at respective memory positions in the work area 62d and counts the number thereof. In this instance, the comparatively large pulse like detection signal at P3 is compared with the predetermined reference value and eliminated as a detection signal of a foreign matter.

Further, the above predetermined reference value is selected as a level that can eliminate the detection signal at point P3 in connection with a foreign matter and can detect a flaw due to a chuck trace or other flaws.

The MPU 61 subsequently calls the defect size judgment program 62b.

The defect size judgment program 62b is executed by the MPU 61, and the MPU 61 classifies the defects into three grades of large, medium and small from the levels of the respective defect detection signals Sk stored in a predetermined memory position in the work area 62d and stores the classification result in another predetermined memory position in the work area 62d. Then the MPU 61 calls the disk good or no good judgment program 62c.

The disk good or no good judgment program 62c is executed by the MPU 61, and the MPU 61 determines a disk having one large defect as no good with reference to the size classification data stored in the work area 62d. A disk having more than two medium defects is also determined as no good. Further, a disk having not less than five defects is also determined as no good. As the result of the good or no good judgment, when a disk of which front face side is determined as no good, the result is displayed on the display 63 and the no good disk is removed from the spindle 2 with a handling robot and is transferred to a no good cassette (NG cassette).

With regard to a disk that is determined as good in the inspection of the front face side chamfered portion ChU, the MPU 61 drives the disk inverting mechanism 8 to invert the good disk and to remount the same to the spindle 2 while setting the back face side chamfered portion ChD as the outer peripheral chamfered portion 1d.

Then, after waiting an index signal IND, the same inspection as above is performed for the back face side chamfered portion ChD.

At the time when the good or no good judgment has been completed for the back face side, the result of good or no good judgment of the inspected disk is displayed on the display 63 and a no good disk is transferred to the NG cassette.

As a result, a disk determined as no good either in connection with the front face or the back face is accommodated in the NG cassette and a disk as determined as G (good) is accommodated in a good (G) cassette, thereby, an inspection of a disk 1 is completed and the inspection moves subsequently to a new disk for inspection object.

Now, as explained above, in FIG. 1 embodiment, although the pulse like inspection signal at point P3 is eliminated through comparison with the predetermined reference value, discrimination between the detection signal at point P3 and the detection signal at point KF can be performed through a provision between the comparing amplifier 54 and the A/D 55 of a comparator that compares a defect detection signal Sk with a predetermined reference value to thereby eliminate the detection signal at point P3 from the defect detection signal Sk. An example therefor will be explained in the followings.

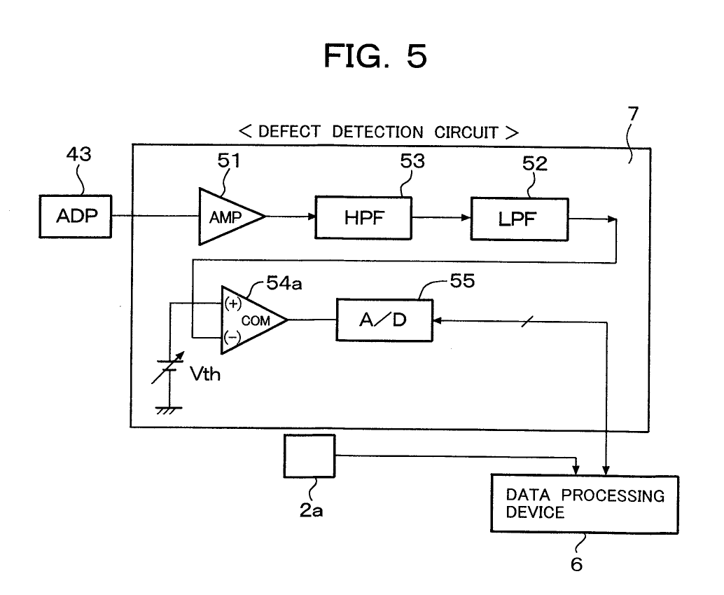

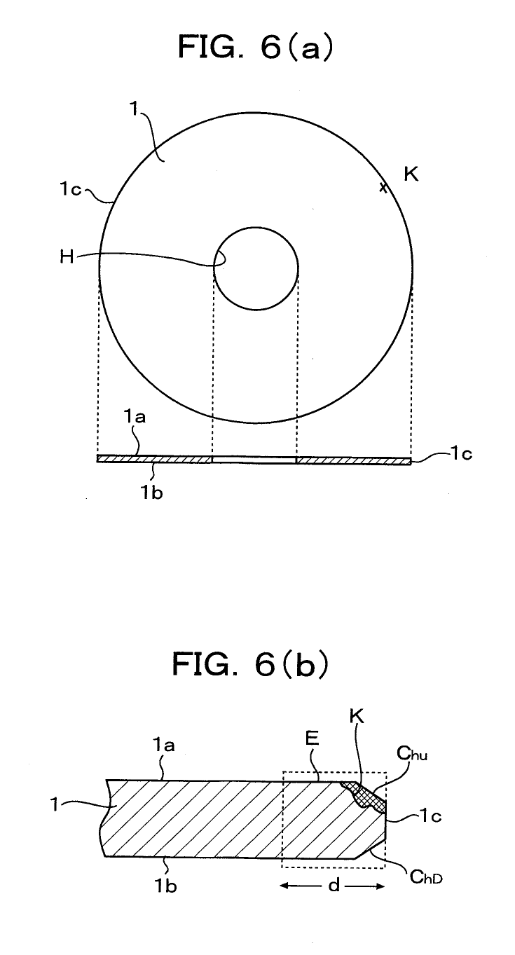

FIG. 5 is a block diagram of a defect inspection circuit, which uses another reference level variation inhibiting circuit in a received light signal, wherein the defect detection device 10 uses a defect detection circuit 7 in place of the defect detection circuit 5 in FIG. 1.

In the defect detection circuit 7, the connecting relationship between the LPF 52 and the HPF 53 is inverted, in that at the back of the HPF 53 the LPF 52 is connected in cascade. The output of the LPF 52 is input to a comparator 54a and the output “1” or “0” of the comparator 54a is input to the A/D 55. Thereby, when the interval of “1” of the comparator 54a is long, the level “1” for the corresponding period is continuously A/D converted with a predetermined period.

Further, in place of the A/D 55, through provision of a defect bit memory, bit data corresponding to one round rotation of the disk can be stored so as to permit the MPU 61 to read the bit data.

Usually, the cascade connection of the LPF 53 to the HPF 52 constitutes a BPF (Band Pass Filter).

Herein, giving the cutoff frequency of the HPF 53 as 200 Hz, and keeping the variation frequency of the signal reference level in a received light signal corresponding to a frequency due to the shifting in up and down direction of the outer peripheral surface of a disk below the cutoff frequency, the frequency due to the shifting in up and down direction of the outer peripheral surface of the disk is eliminated and a smoothened signal of the signal reference level is extracted. Thereby, the variation of the reference level in the received light signal is suppressed.

The cutoff frequency of the LPF 52 is given as 3 MHz. The LPF 52 is a filter for cutting off high frequency noises from the received light signal and for eliminating defect detection signals including foreign matters.

Resultantly, through provision of a BPF having a band of 200 Hz˜3 MHz constituted by the HPF 53 and the LPF 52, the defect detection signals are extracted.

When the defect detection signals are inputted to (−) input of the comparator 54a to which (+) input side a reference value (threshold value) Vth serving as a comparison reference is applied, the high frequency noise components and the respective detection signals at points P1, P2 and P3 corresponding to foreign matters are cut off from the defect detection signals and the detection signal at point KF in which the detection signal at point P3 is removed from the defect detection signal Sk is obtained as shown in FIG. 4 (b).

Further, the reference value Vth in the comparator 54a is adjusted as a value that removes the detection signal at point P3.

Although in FIG. 1 embodiment the use of the comparing amplifier has been explained, when the level of the received light signal amplified by an amplifier is large, a usual comparator or a differential amplifier can be used.

Further, although in the embodiment an example of an aluminum disk (an aluminum substrate, a magnetic disk including an aluminum substrate) has been explained, the present invention is not limited to the aluminum disk and is applicable to a magnetic disk including a glass substrate, other media disks and the like.

Further, although the light receiver in the embodiment uses the APD, the present invention can use varieties of light receiving elements such as a CCD and a photo multiplier and of light receivers.

Still further, although in the embodiment, only the front face side chamfered portion of a disk is assumed as the inspection object, in the present invention, through provision of a light receiver that corresponds to the back face side chamfered portion and through irradiation of light beams to the back face side chamfered portion, outer peripheral defects on the back face side chamfered portion can be detected with the light receiver provided at the back face side. Further, the present invention can be modified to detect outer peripheral defects at both front and back face chamfered portions at the same time.

Still further, although in the embodiment, as the irradiation light the laser beams are used, the irradiation light can, of course, be white light.

Still further, throughout the present specification, the term defect is used not only for such as breaks and chips but also used in a broad sense for flaws in general, and the same is true with regard to claims follows.

1. A detection method of a peripheral surface defect of a disk for detecting a defect on an outer peripheral surface of the disk comprising the steps of:
irradiating light beams on a surface of an outer peripheral chamfered portion of the disk that is rotatable with an incident angle in a range of 45°±5°,
receiving regularly reflected light from the outer peripheral chamfered portion by a light receiver provided away from the outer peripheral chamfered portion by a predetermined distance through a stop to obtain a received light signal and
obtaining a detection signal of a defect on the outer peripheral surface while suppressing or canceling out a variation of signal reference level in the received light signal due to a shifting of the outer peripheral surface of the disk caused by rotation of the disk.

2. A detection method of a peripheral surface defect of a disk according to claim 1, wherein a hole diameter of the stop is selected so as to permit the regularly reflected light corresponding to the width of the outer peripheral chamfered portion to pass therethrough.

3. A detection method of a peripheral surface defect of a disk according to claim 2, wherein in order to suppress or cancel out the variation of signal reference level in the received light signal, the received light signal is caused to pass a filter circuit of either a low pass filter or a band pass filter which passes a signal having a frequency corresponding to the variation of signal reference level, or a high pass filter which prevents the signal having a frequency corresponding to the variation of signal reference level and the detection signal of a defect on the outer peripheral surface is obtained based on a signal obtained from the filter circuit.

4. A detection method of a peripheral surface defect of a disk according to claim 3, wherein the filter circuit includes other high pass filter which removes high frequency noises and a defect detection signal, the signal having a frequency corresponding to the variation of the signal reference level is obtained through the other high pass filter and one of the low pass filter and the band pass filter, and the detection signal of the defect at the outer peripheral surface is obtained through comparison of the signal with the received light signal.

5. A detection method of a peripheral surface defect of a disk according to claim 3, wherein the high pass filter is a band pass filter, the filter circuit eliminates a signal having a frequency due to the shifting of the outer peripheral surface by the band pass filter and extracts the received light signal in which signal reference level is smoothened and the detection signal of a defect at the outer peripheral surface is obtained based on the extracted received light signal.

6. A detection method of a peripheral surface defect of a disk according to claim 5, wherein the extracted received light signal is compared by a comparator with a predetermined reference value and the detection signal of a defect at the outer peripheral surface is obtained.

7. A detection method of a peripheral surface defect of a disk according to claim 3, wherein the stop is provided between the light receiver and a image-forming lens which receives the regularly reflected light from the outer peripheral chamfered portion.

8. A detection device of a peripheral surface defect of a disk for detecting a defect on an outer peripheral surface of the disk comprising:
a light illuminating system that irradiates light beams on a surface of an outer peripheral chamfered portion of the disk that is rotatable with an incident angle in a range of 45°±5°,
a light receiver that is provided away from the outer peripheral chamfered portion by a predetermined distance, receives regularly reflected light from the outer peripheral chamfered portion through a stop and generates a received light signal and
a reference level variation inhibiting circuit that suppresses or cancels out a variation of signal reference level in the received light signal due to shifting of the outer peripheral surface of the disk caused by rotation of the disk,
wherein a detection signal of a defect at the outer peripheral surface is obtained based on a signal obtained from the reference level variation inhibiting circuit.

9. A detection device of a peripheral surface defect of a disk according to claim 8, wherein a hole diameter of the stop is selected so as to permit the regularly reflected light corresponding to the width of the outer peripheral chamfered portion to pass therethrough.

10. A detection device of a peripheral surface defect of a disk according to claim 9, wherein the reference level variation inhibiting circuit includes a filter circuit of either a low pass filter or a band pass filter which passes a signal having a frequency corresponding to the variation of signal reference level, or a high pass filter which prevents the signal having the frequency corresponding to the variation of signal reference level and the detection signal of a defect at the outer peripheral surface is obtained based on a signal obtained after the received light signal has passed through the filter circuit.

11. A detection device of a peripheral surface defect of a disk according to claim 10, wherein the filter circuit includes either the low pass filter or the band pass filter and other high pass filter which removes high frequency noises and a defect detection signal and the reference level variation inhibiting circuit removes the high frequency noises and the defect detection signal through the other high pass filter and obtains a signal having a frequency corresponding to the variation of the signal reference level as a detection reference signal through the other high pass filter and obtains the defect detection signal with regard to the defect at the outer peripheral surface through comparison of the detection reference signal with the received light signal.

12. A detection device of a peripheral surface defect of a disk according to claim 11, wherein the light beams are laser beams, the light receiver is disposed in perpendicular direction with respect to the front face of the disk and the detection reference signal and the received light signal are compared by one of a comparing amplifier, a comparator and a differential amplifier.

13. A detection device of a peripheral surface defect of a disk according to claim 10, wherein the high pass filter is a band pass filter, the band pass filter eliminates a signal having a frequency due to the shifting of the outer peripheral surface and extracts the received light signal in which signal reference level is smoothened and the detection signal of a defect at the outer peripheral surface is obtained based on the extracted received light signal.

14. A detection device of a peripheral surface defect of a disk according to claim 13, further comprising a comparator and wherein the light beams are laser beams, the light receiver is disposed in perpendicular direction with respect to the front face of the disk, the extracted received light signal is compared by the comparator with a predetermined reference value and the detection signal of a defect at the outer peripheral surface is obtained based on an output signal of the comparator.

15. A detection device of a peripheral surface defect of a disk according to claim 14, further comprising an A/D converting circuit and wherein the defect detection signal is inputted to the data processing device after being converted into a digital value by the A/D converting device and the data processing device judges defects at the outer peripheral surface depending on the level of the defect detection signal and further judges good or no good of the disk based on the number of defects at the outer peripheral surface.

16. A detection device of a peripheral surface defect of a disk according to claim 15, wherein the disk is any one of selected from an aluminum substrate, a magnetic disk including an aluminum substrate, a magnetic disk including a glass substrate and other media disks.

17. A detection device of a peripheral surface defect of a disk according to claim 9, further comprising a image-forming lens for receiving the light beams from the outer peripheral chamfered portion, wherein the stop is provided between the light receiver and the image-forming lens.
